(19) United States
(12) Patent Application Publication
(10) Pub. No.: US 2019/0235863 A1
(43) Pub. Date: Aug. 1, 2019

(54) SORT INSTRUCTIONS FOR RECONFIGURABLE COMPUTING CORES

(71) Applicant: QUALCOMM Incorporated, San Jose, CA (US)

(72) Inventors: Ioannis NOUSIAS, San Diego, CA (US); Mark IR MUIR, San Diego, CA (US); Sami KHAWAM, San Diego, CA (US)

(21) Appl. No.: 16/004,335

(22) Filed: Jun. 8, 2018

Related U.S. Application Data
(60) Provisional application No. 62/624,763, filed on Jan. 31, 2018.

(51) Int. Cl. G06F 9/30

(52) U.S. Cl. CPC G06F 9/3001; G06F 9/30072

(57) ABSTRACT

According to various aspects, a sorting instruction described herein may advantageously be implemented using intrinsic properties of a reconfigurable computing engine. For example, the reconfigurable computing engine may comprise an arithmetic logic unit (ALU) or other suitable operational unit(s) that can perform one or more comparisons among a given plurality of inputs and output a plurality of select signals that at least indicate maximum and minimum values among the given plurality of inputs. In addition, the reconfigurable computing engine may comprise various multiplexers that make up an interconnect fabric coupled to the ALU or other suitable operational units, wherein the multiplexers may be arranged to receive the plurality of inputs and the plurality of select signals such that the plurality of multiplexers can be dynamically configured to perform the permutations to sort the plurality of inputs.

### CROSS-REFERENCE TO RELATED APPLICATIONS

The present application claims the benefit of U.S. Provisional Application No. 62/624,763, entitled “SORT INSTRUCTIONS FOR RECONFIGURABLE COMPUTING CORES,” filed Jan. 31, 2018, the contents of which are hereby expressly incorporated by reference in their entirety.

### TECHNICAL FIELD

The various aspects and embodiments described herein relate to sort instructions that may advantageously be implemented in reconfigurable computing cores.

### BACKGROUND

Although microprocessor computing power has been progressively increased, the need for additional increases remains unabated. For example, smart phones now burden their processors with a bewildering variety of tasks. But a single core processor can only accommodate so many instructions at a given time. Thus, it is now common to provide multi-core or multi-threaded processors that can process sets of instructions in parallel. Nonetheless, such instruction-based architectures must always battle the limits imposed by die space, power consumption, and complexity with regard to decreasing the instruction processing time. As compared to the use of a programmable processing core, there are many algorithms that can be more efficiently processed in dedicated hardware. For example, image processing involves substantial parallelism and processing of pixels in groups through a pipeline of processing steps. If the algorithm is then mapped to hardware, the implementation takes advantages of this symmetry and parallelism. But designing dedicated hardware is expensive and also cumbersome in that if the algorithm is modified, the dedicated hardware must be redesigned.

To provide an efficient compromise between instruction-based architectures and dedicated hardware approaches, reconfigurable computing engines have emerged as a relatively recent new class of computing architectures that combine at least some of the flexibility of software with the high performance of hardware. There are of course a wide range of implementations and designs, but there are a number of common themes among them. For example, reconfigurable computing engines typically have a set of reprogrammable or reconfigurable operational units that perform a data crunching function. These operational units can range from primitive operations (e.g., adder, shifter, Boolean, etc.), to aggregates of the above, as arithmetic logic units (ALUs) that can be configured to perform any of those primitive operations, all the way to full-fledged execution engines (e.g., central processing units). Furthermore, reconfigurable computing engines typically have some kind of reprogrammable or reconfigurable communication network (or “fabric”) that allows the operational units to exchange data (e.g., a simple bus or crossbar, a connection-based switching network, a packet-based switching network, etc.) and one or more interfaces to the outside world that allow the reconfigurable computing engine to receive data to process and send the results.

Accordingly, those skilled in the art will appreciate that reconfigurable computing engines may have various advantageous aspects, including the ability to make substantial changes to a datapath in addition to the control flow and the ability to adapt hardware during runtime by (re)programming or (re)configuring the fabric. As such, a reconfigurable computing engine could provide a suitable architecture to implement any number of algorithms that may be processed efficiently in hardware. For example, an algorithm such as image processing that involves processing multiple pixels through a pipelined processing scheme can be mapped to operational units in a manner that emulates a dedicated hardware approach. But there is no need to design dedicated hardware; instead one can merely program the operational units and switching fabric as necessary. Thus, if an algorithm must be redesigned, there is no need for hardware redesign but instead a user may merely change the programming as necessary.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to various aspects, a sorting instruction described herein may advantageously be implemented using intrinsic properties of a reconfigurable computing engine. For example, the reconfigurable computing engine may comprise an arithmetic logic unit (ALU) or other suitable operational units that can perform one or more comparisons among a given plurality of inputs and output a plurality of select signals that at least indicate maximum and minimum values among the given plurality of inputs. In addition, the reconfigurable computing engine may comprise various multiplexers that make up an interconnect fabric (or switching fabric) coupled to the ALU or other suitable operational units, wherein the multiplexers may be arranged to receive the plurality of inputs and the plurality of select signals such that the plurality of multiplexers can be dynamically configured to perform the permutations to sort the plurality of inputs in ascending or descending order.

According to various aspects, a circuit may comprise an ALU configured to receive an input signal comprising N input values to be sorted and to drive N select signals that at least indicate a maximum value and a minimum value among the N input values, where N is an integer having a value greater than one and an output switching fabric configured to receive the N input values and the N select signals driven by the ALU, wherein the output switching fabric may comprise N multiplexers collectively configured to output at least the maximum value and the minimum value among the N input values based on the N select signals. In various embodiments, the ALU and the output switching fabric may be provided in a switch box associated with a reconfigurable instruction cell array having multiple switch boxes that are arranged into one or more rows and one or more columns. The N multiplexers may be individually configured to receive the N input values and a respective one of the N select signals, which may comprise at least a first select signal that indicates the maximum value among the N input values and a second select signal that indicates the minimum value among the N input values such that the N multiplexers are configured to output the maximum value based on the first select signal and the minimum value based on the second select signal. Furthermore, in various embodiments, the N select signals may further comprise a third select signal that indicates a middle value among the N input values such that the N multiplexers may be further configured to output the middle value among the N input values based on the third select signal. In various embodiments, the circuit may be one of a plurality of N-way sort units in a median filter configured to output a median value among the N input values.

According to various aspects, a method may comprise receiving, at an ALU, an input signal comprising N input values to be sorted, where N is an integer having a value greater than one, driving, by the ALU, N select signals that at least indicate a maximum value and a minimum value among the N input values, the ALU coupled to an output switching fabric comprising N multiplexers arranged to receive the N input values and the N select signals, and outputting, by the output switching fabric, at least the maximum value and the minimum value among the N input values based on the N select signals driven by the ALU.

According to various aspects, a reconfigurable instruction cell array may comprise multiple switch boxes arranged into one or more rows and one or more columns, wherein at least one of the multiple switch boxes comprises an ALU configured to receive an input signal comprising N input values to be sorted and to drive N select signals that at least indicate a maximum value and a minimum value among the N input values, where N is an integer having a value greater than one and an output switching fabric configured to receive the N input values and the N select signals driven by the ALU, wherein the output switching fabric comprises N multiplexers collectively configured to output at least the maximum value and the minimum value among the N input values based on the N select signals.

According to various aspects, an apparatus may comprise means for driving N select signals that at least indicate a maximum value and a minimum value among N input values, where N is an integer having a value greater than one and an output switching fabric configured to receive the N input values and the N select signals, wherein the output switching fabric comprises N multiplexers collectively configured to output at least the maximum value and the minimum value among the N input values based on the N select signals.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIG. 1A illustrates an exemplary reconfigurable computing engine that may advantageously be used to implement sort instructions, according to various aspects.

FIG. 1B illustrates an exemplary array of switch boxes that may be used in the reconfigurable computing engine shown in FIG. 1A, according to various aspects.

FIG. 2 illustrates exemplary input/output (I/O) ports for a switch box in an array of switch boxes as shown in FIG. 1B as well as a channel output multiplexer for one of the I/O ports, according to various aspects.

FIG. 3 illustrates an exemplary median filter that may implement a sorting function using several two-way sort units, according to various aspects.

FIG. 4 illustrates an exemplary median filter that may implement a sorting function using several three-way sort units, according to various aspects.

FIG. 5 illustrates an exemplary data sorting instruction that may advantageously be implemented in a reconfigurable computing engine, according to various aspects.

FIG. 6 illustrates an exemplary comparison circuit that may implement part of the data sorting instruction shown in FIG. 5, according to various aspects.

FIG. 7 illustrates exemplary combinations of values for various signals used to drive the sorting instruction shown in FIG. 5 and FIG. 6, according to various aspects.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

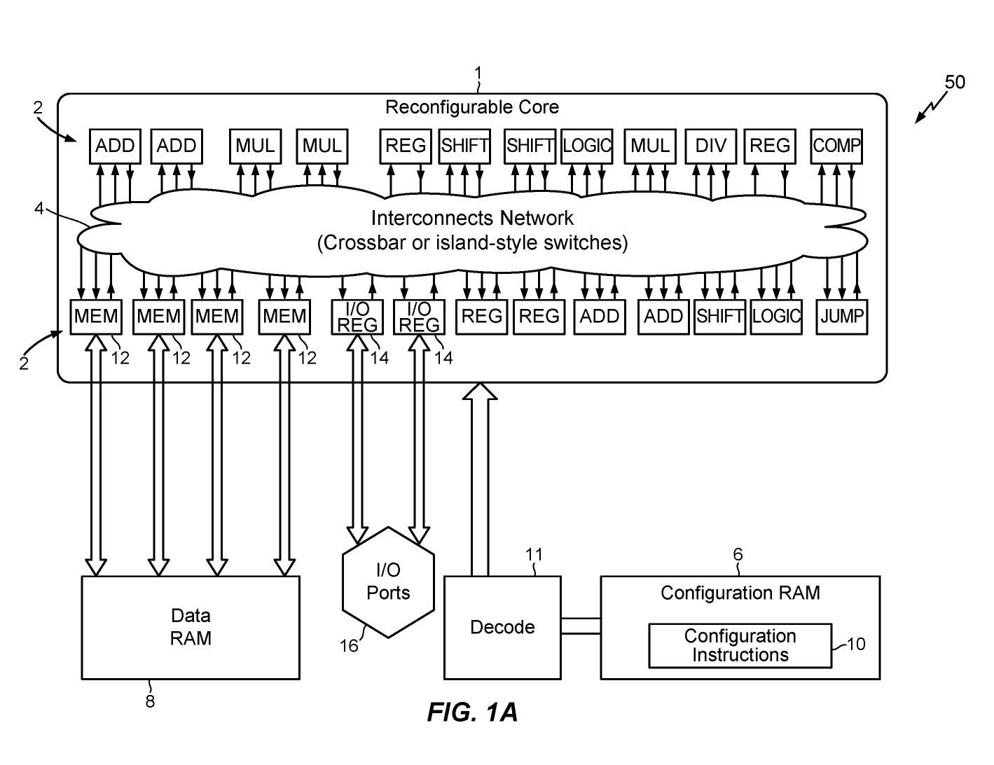

According to various aspects, FIG. 1A illustrates an exemplary reconfigurable computing engine 50 that may advantageously be used to implement sort instructions. In particular, as way of background, the reconfigurable computing engine 50 may be a Reconfigurable Instruction Cell Array (RICA) architecture in which a reconfigurable core 1 includes various instruction cells 2 that are interconnected via an interconnects network 4 that has various programmable switches to allow the creation of datapaths. In a similar way to a CPU architecture, the configuration of the instruction cells 2 and the interconnects network 4 is changeable on every cycle to execute different blocks of instructions. As shown in FIG. 1A, the RICA architecture is similar to a Harvard Architecture CPU where a program (configuration) memory 6 is separate from a data memory 8. In the RICA architecture, the processing datapath is a reconfigurable core of interconnectable instruction cells 2 and the configuration memory 6 contains the configuration instructions 10 (i.e., bits) that control, via a decode module 11, both the instruction cells 2 and the switches inside the interconnects network 4. The interface with the data memory 8 is provided by various memory (MEM) cells 12. Furthermore, one or more input/output register (I/O REG) instruction cells 14 may be mapped to I/O ports 16 to allow interfacing with an external environment.

The characteristics of the reconfigurable core 1 shown in FIG. 1A are fully customizable and can be set according to any suitable application requirements. This includes options such as the bitwidth of the system and the flexibility of the array, which is set by the choice of instruction cells 2 and the interconnects network 4 deployed. The reconfigurable core 1 can be easily programmed or reprogrammed to execute any suitable operation in a similar way to a general purpose processor (GPP). For example, in various embodiments, the array of instruction cells 2 in the RICA architecture is heterogeneous and each instruction cell 2 may be configured to perform one or more operations such as ADD (addition, subtraction), MUL (signed and unsigned multiplication), DIV (signed and unsigned divisions), REG (registers), I/O REG (register with access to external I/O ports), MEM (read/write from data memory 8), SHIFT (shifting operation), LOGIC (logic operation such as XOR, AND, OR, etc.), COMP (data comparison), and JUMP (branches and sequencer functionality).

A further special instruction cell 2 is a multiplexer instruction cell that provides a conditional combinatorial path. By providing an instruction cell 2 that contains a hardwired comparator and a multiplexer, conditional moves identified by a compiler can be implemented as simple multiplexers. Furthermore, when embodied as RICA, multiple execution datapaths can be suitably implemented in parallel. Such a spanning tree is useful in conditional operations to increase the level of parallelism in the execution, and hence reduce the time required to finish the operation. As such, in various embodiments, these and other intrinsic properties of reconfigurable computing engines in general and the RICA architecture shown in FIG. 1A in particular may be used to efficiently implement various algorithms that could benefit from hardware.

According to various aspects, FIG. 1B illustrates an exemplary array 100 of switch boxes that may be used in the RICA architecture shown in FIG. 1A. In general, in a reconfigurable array such as the RICA architecture shown in FIG. 1A, the instruction cells may be arranged by rows and columns Each instruction cell, any associated register, and the input and output switching fabric may be considered to reside within a switch box, wherein FIG. 1B shows an example where the switch boxes making up the array 100 are arranged in rows and columns. The switching fabric in each switch box may generally accommodate a data path that might begin at a given switch box 101 at some row and column location and then end at some other switch box 105 at a different row and column location. For example, as shown in FIG. 1, the data path may start at switch box 101 and then proceed to a second switch box 115 in the same row and an adjacent column (e.g., in an “east direction” from the switch box 101), wherein an output from the first switch box 101 may be provided as an input to the second switch box 115, as depicted at 102. The data path may then proceed through various additional switch boxes before eventually ending at switch box 105. In this data path, two instruction cells are configured as arithmetic logic units (ALUs) 110. The instruction cells for the remaining switch boxes are not shown for illustration clarity. Note that for the datapath to begin at switch box 101 and then end at switch box 105, each switch box may generally accommodate two switching matrices or fabrics. In particular, each switch box as shown in FIG. 1B may include an input switching fabric to select for the inputs to the instruction cell (e.g., ALUs 110) and each switch box may further include an output switching fabric to select for the outputs from the switch box.

In contrast to an instruction cell as used in the RICA architecture contemplated herein, the logic block in a field programmable gate array (FPGA) uses lookup tables (LUTs). For example, suppose one needs an AND gate in the logic operations carried out in a configured FPGA. A LUT would then be programmed with the truth table for the AND gate logical function. But an instruction cell is much coarser-grained in that the instruction cell contains dedicated logic gates. For example, the ALU instruction cells 110 as shown in FIG. 1B may include assorted dedicated logic gates, whereby the function of the ALU instruction cells 110 is configurable (i.e., the primitive logic gates of the ALU instruction cells 110 are dedicated gates and thus non-configurable). For example, a conventional CMOS inverter is one type of dedicated logic gate. There is nothing configurable about such an inverter, which needs no configuration bits. Instead, the instantiation of an inverter function in a FPGA programmable logic block is performed by a corresponding programming of a LUT truth table. Thus, as used herein, those skilled in the art will appreciate that the term “instruction cell” may generally refer to a configurable logic element that comprises one or more dedicated logic gates.

Referring to FIG. 1A in conjunction with FIG. 1B, an instruction cell may perform a logical function on one or more operands to form an instruction cell output. An operand in this context is a received input channel. Depending upon its configuration bits, an instruction cell may be configured to perform corresponding logical operations. For example, a first switch box may include an ALU instruction cell configured to add two or more operands that correspond to respective channel inputs. But the same ALU instruction cell may later be updated to perform a different logical operation on the two or more operands. The instruction cell output that results from the logical operation performed within the instruction cell may be an input to another instruction cell. Thus, the output switching fabric in the first switch box would be configured to drive the instruction cell output out of the first switch box through corresponding channel outputs. In contrast, the LUTs in an FPGA each produce a bit rather than words. As such, the switching fabric in an FPGA is fundamentally different from the switching fabrics in a RICA architecture in that the switching fabric in an FPGA is configured to route the bits from the LUTs associated with the FPGA. In contrast, the routing between switch boxes in a RICA architecture is configured to route words as both input channels and output channels. For example, a switch box array may be configured to route twenty (20) channels. Switch boxes in such an embodiment may thus receive twenty input channels from all four directions (as defined by the row and column dimensions) and drive twenty output channels in the four directions. The column dimension may be considered to correspond to the north and south directions for any given switch box, and the row dimension may similarly be considered to correspond to the east and west directions.

According to various aspects, each output channel from a switch box may be selected for by a corresponding channel output multiplexer within the switch box. Such a channel output multiplexer may comprise a collection of output multiplexers, each of which may correspond to one bit of the channel word width. Although the following discussion refers to the channel output multiplexer that selects for the entire channel, those skilled in the art will understand that such a channel output multiplexer may actually comprise multiple output multiplexers that each have a single bit output. With regard to any given output direction (e.g., north, south, east, or west), there are three possible input directions remaining. For example, a north output channel may be selected from east, west, and south input channels. Each channel output multiplexer for a given output direction could thus comprise a 3:1 multiplexer. However, an output channel may also be driven by the output from an instruction cell provided in the switch box. Thus, each channel output multiplexer may potentially comprise a 4:1 multiplexer in a RICA switch box. Assuming that the column channels travel in north and south directions, a switch box would thus require twenty 4:1 channel output multiplexers to drive the north output channels and another twenty 4:1 channel output multiplexers to drive the south output channels in a twenty channel embodiment. Similarly, row channels may be assumed to travel in the east and west directions, whereby a switch box in a twenty channel embodiment would include twenty 4:1 channel output multiplexers to drive the east output channels and twenty 4:1 channel output multiplexers to drive the west output channels. The resulting set of 4:1 channel output multiplexers for all four directions forms the output switching fabric for each switch box.

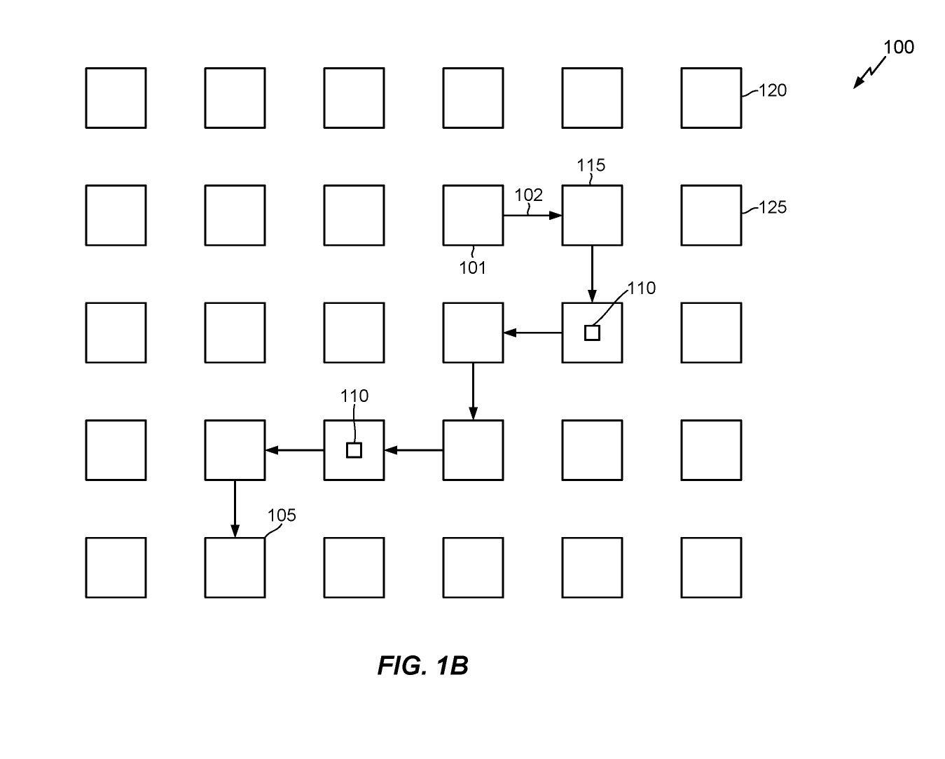

For example, according to various aspects, FIG. 2 illustrates exemplary input/output (I/O) ports for an example switch box 205 in an array 220 of switch boxes as well as a channel output multiplexer 200 for one of the I/O ports. In particular, FIG. 2 shows the channel input and output directions for the example switch box 205 in the array 220. Given this north, south, east, and west routing corresponding to the row and column arrangement of the switch boxes, each switch box such as switch box 205 may be considered to include an input/output (I/O) port for each direction. For example, switch box 205 has a west I/O port 225, a south I/O port 230, a north I/O port 235, and an east I/O port 240. At each I/O port, the switch box 205 receives the plurality of input channels and outputs the plurality of output channels. For example, switch box 205 receives all the south input channels through south I/O port 230. Similarly, switch box 205 drives all the south output channels through south I/O port 230. Each I/O port thus comprises the output switching fabric for driving the I/O port output channels.

With regard to each I/O port, the output channels are selected for by corresponding channel output multiplexers. Each output channel thus has a corresponding channel output multiplexer at any given I/O port. For illustration clarity, only a single channel output multiplexer 200 is shown for an east output channel for east I/O port 240 in switch box 205. This channel will be designated as the ith east output channel in that the particular channel ‘i’ it represents is arbitrary. Additional east output channels would be provided by analogous channel output multiplexers.

Similarly, the north, south, and west output channels would also be selected for by their own corresponding channel output multiplexers. The resulting set of I/O ports 225, 230, 235, and 240 (each one comprising a plurality of channel output multiplexers) makes up the output switching fabric for switch box 205. With regard to any particular output channel driven out of a given I/O port, the corresponding channel output multiplexer may be configured to select for the same input channel received by the I/O port in the opposite direction. For example, an ‘ith’ west output channel may be driven by the ith east input channel, where i is some arbitrary channel number. Similarly, an ith north output channel may be driven by an ith south input channel and so on.

Since channel output multiplexer 200 is driving the ith east output channel, the channel output multiplexer 200 may receive an ‘in_opp’ input channel that corresponds to the west input for channel i. The in_opp input channel may also be referred to as the opposite input channel Each channel output multiplexer may also select from one or more input channels received at the I/O ports in the orthogonal directions. In other words, the channel output multiplexer for a west output channel may select from orthogonal input channels in the north and south directions as well as the opposite input channel in the east direction. Similarly, the channel output multiplexer for a north output channel may select from the orthogonal input channels in the east and west directions as well as the opposite input channel in the south direction. In that regard, the orthogonality for such a selection may be denoted as being either clockwise or anti-clockwise with regard to the output direction for a channel output multiplexer. For example, from the perspective of channel output multiplexer 200, an anti-clockwise rotation is used to select from a north input channel and a clockwise rotation would be used to select from a south input channel for channel output multiplexer 200.

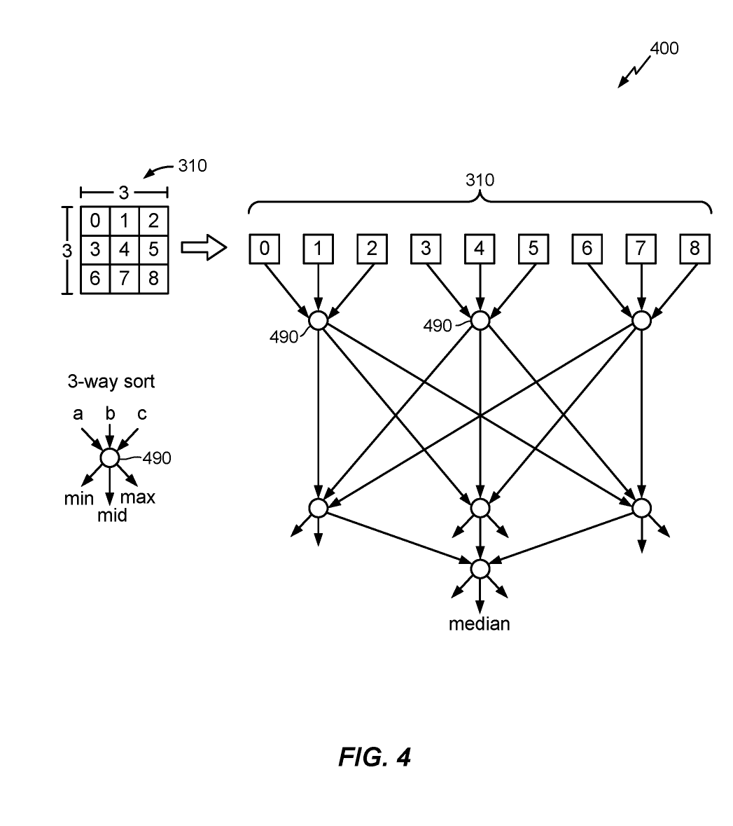

Thus, in an illustrative and representative example, when configured as a 4:1 multiplexer, the channel output multiplexer 200 can select from the instruction cell output word (in_co), an anti-clockwise input channel (in_acw), the opposite input channel (in_opp), and a clockwise input channel (in_cw) in order to drive the ith output channel. Alternatively, in one variant when configured as a 3:1 multiplexer, the channel output multiplexer 200 can select from the anti-clockwise input channel (in_acw), the opposite input channel (in_opp), and the clockwise input channel (in_cw) while the instruction cell output word (in_co) can be used to drive the configuration bits (or “select signal”) that the channel output multiplexer 200 uses to select from among the available inputs to the channel output multiplexer 200. One possible configuration of such a 3:1 multiplexer is shown in FIG. 5 and described in further detail below.

Referring again to FIG. 1B, certain switch boxes such as a switch box 120 at the edge of the array may have one or more I/O ports that do not face a neighboring switch box. For example, an east I/O port for switch box 120 has no neighboring switch box to the east. Thus, the output channels from I/O ports that do not face other switch boxes may be configured to ‘wrap around’ to an adjacent switch box. For example, in various embodiments, the east output channel(s) from switch box 120 may be wrapped around to become the east input channel(s) to an adjacent switch box 125.

According to various aspects, further detail relating to the RICA architecture(s) shown in FIG. 1A, FIG. 1B, FIG. 2 and/or variants thereof is provided in commonly owned U.S. Patent Publication No. 2010/0122105, entitled “RECONFIGURABLE INSTRUCTION CELL ARRAY,” and in commonly owned U.S. Patent Publication No. 2014/0359174, entitled “RECONFIGURABLE INSTRUCTION CELL ARRAY WITH CONDITIONAL CHANNEL ROUTING AND IN-PLACE FUNCTIONALITY,” the contents of which are each hereby incorporated by reference in their entirety.

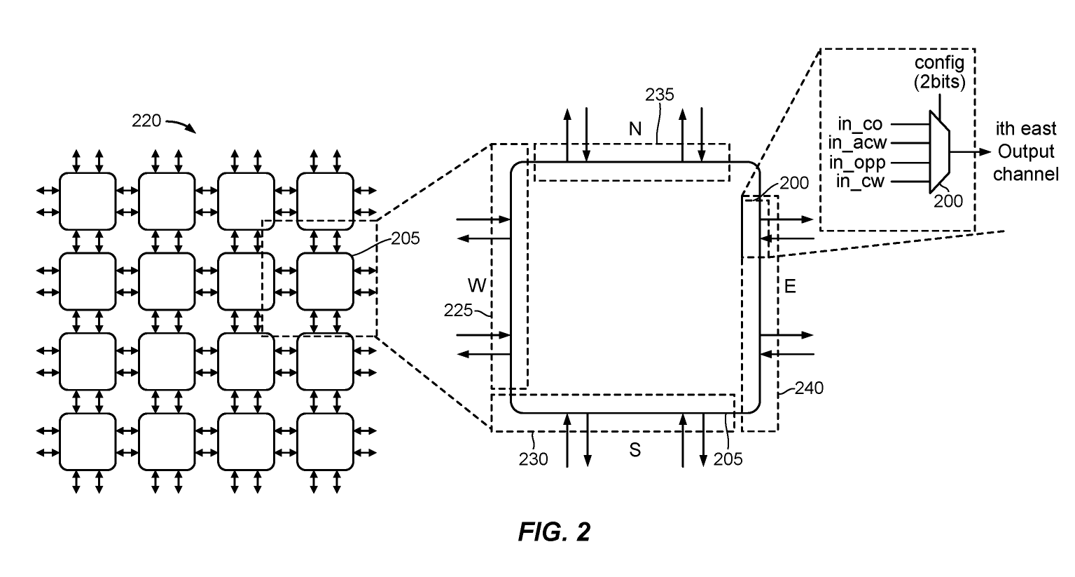

According to various aspects, a feature of the RICA architecture as shown in FIG. 1A, FIG. 1B, and FIG. 2 is that both the instruction cells and the elements that make up the interconnects network (or “switching fabrics”) are programmable and dynamically reconfigurable in every clock cycle. The basic and core elements of the RICA architecture are the programmable instruction cells, which can be programmed to execute one operation similar to a CPU instruction. For example, the following description provides an illustrative example in which one or more instruction cells and one or more elements that make up the interconnects network in a RICA architecture can be appropriately (re)programmed or (re)configured to efficiently perform a data sorting operation, which is a versatile operation that finds a number of uses in a wide range of application domains. For example, in imaging applications, the most common use is in median filters, which are non-linear filters used to remove speckle noise from images, often as a pre-processing stage (e.g., to improve the results of later processing steps such as edge detection). At a high-level, the median filter is generally used to find the median value among several values in a given input signal. Median filters are simple in conception but tend to be computationally heavy. For example, a 3×3 median filter 300 as shown in FIG. 3 requires nineteen (19) comparison operations 390 and a large set of swaps, making the data sort a heavy weight function.

Referring to FIG. 3, when used to remove speckle noise from an image, the 3×3 median filter 300 may sort nine (9) pixels in a 3×3 image patch 310 in an ascending or descending order according to value. The goal of the median filter 300 is to output the median value among the pixels in the image patch 310. Accordingly, each comparison operation 390 in the graph represents a two-way sort, which may be an ascending sort or a descending sort. More particularly, for an ascending sort, each comparison operation 390 is a ‘greater than’ operation 392 that takes ‘a’ and ‘b’ as inputs with a conditional ‘swap’ occurring in the event that ‘a’ is greater than ‘b’. On the other hand, for a descending sort, the operation 392 may be a ‘less than’ comparison with the conditional swap occurring if ‘a’ is less than ‘b’. In a hardware implementation, the swap may be implemented using two 2:1 multiplexers 394 arranged in a crisscross topology and sharing the same select signal, which is the output from operation 392. The multiplexers 394 may therefore be arranged to complement each other such that one chooses the opposite of the other. Accordingly, because the 3×3 median filter 300 shown in FIG. 3 requires nineteen (19) comparison operations 390, implementing the median filter 300 in hardware would require nineteen (19) comparators to perform the operations 392 and thirty-eight (38) 2:1 multiplexers 394 to implement the conditional swaps. These resource requirements would be nearly tripled in a 4×4 median filter.

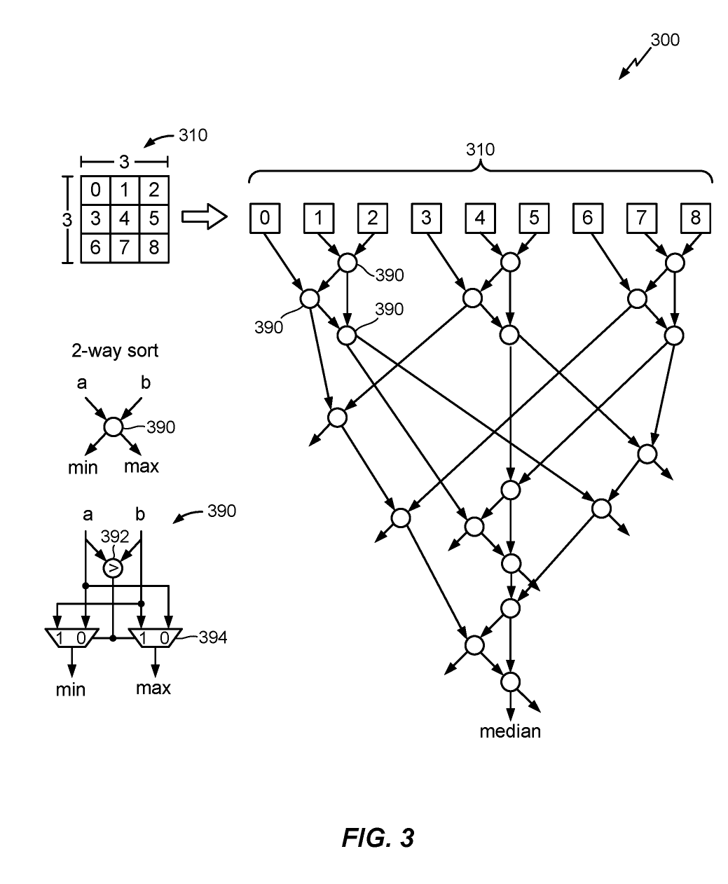

The above representation is based on two-way sort units. However, increasing the granularity to a three-way sort may deliver a more compact data-flow graph, as shown in FIG. 4, which illustrates an exemplary median filter 400 in which each three-way sort unit 490 comprises three (3) comparators, three 3:1 multiplexers, and suitable encode logic such that three inputs can be sorted according to minimum, middle, and maximum values. Accordingly, the following description details how such a grouping of comparators, multiplexers, and encode logic may be advantageously implemented in a reconfigurable computing engine, using the RICA architecture shown in FIG. 1A, FIG. 1B, and FIG. 2 as an example, resulting in a more efficient implementation.

More particularly, according to various aspects, FIG. 5 illustrates an exemplary circuit 500 that may advantageously implement a data sorting instruction using intrinsic properties of a reconfigurable computing engine. For example, referring again to FIG. 1A, FIG. 1B, and FIG. 2, the interconnects network (or switching fabric) in a RICA architecture can comprise various multiplexers that can be driven by the datapath as implemented in the instruction cells. That means that the instruction cells can be configured to perform an appropriate computation such that a result of the computation can drive one or more multiplexer select signals and thereby choose what signal to output. For example, FIG. 5 shows an example implementation in which three 3:1 multiplexers 532, 534, 536 are each able to perform a 3:1 selection given a two-bit input select signal, although those skilled in the art will appreciate that the concept may be applicable to more inputs. For example, in various embodiments, the concepts described herein may be used to implement a combination of two-way and three-way (or higher) arity sorts to form an N-sized median filter. The difference is that in the case of a two-way sort, the ‘greater than’ comparator (or ‘less than’ comparator in the case of a descending sort) drives the one-bit input of a 2:1 multiplexor, while in a three-way and above sort, the outputs from the comparators are combined or otherwise “encoded” into the two-bit signal of a 3:1 (or wider) multiplexer. As such, the various aspects and embodiments described herein emphasize three-way and above sorts because the above-mentioned “encoding” makes such a sort a “special” arithmetic logic unit (ALU) instruction, unlike a two-way sort that can be implemented with one comparator.

According to various aspects, with specific reference now to FIG. 5, the three-way sorting circuit 500 illustrated therein may pair an instruction performed in an arithmetic logic unit (ALU) 520 with the three 3:1 multiplexers 532, 534, 536 that make up an interconnect or switching fabric. For example, as shown in FIG. 5, the ALU 520 may receive an input signal 510 that comprises three individual input values 510-1, 510-2, 510-3 to be sorted according to a maximum value 552, a middle value 554, and a minimum value 556. In various embodiments, the ALU 520 may perform the various comparisons necessary for sorting, while the multiplexers 532, 534, 536 that make up the interconnect fabric may carry out the necessary permutations (or “shuffling”) to output the maximum value 552, the middle value 554, and the minimum value 556 based on the sorting order determined in the ALU 520. This decoupling may efficiently use existing resources in a reconfigurable processor, such as a reconfigurable computing engine based on the RICA architecture as shown in FIG. 1A, FIG. 1B, and FIG. 2.

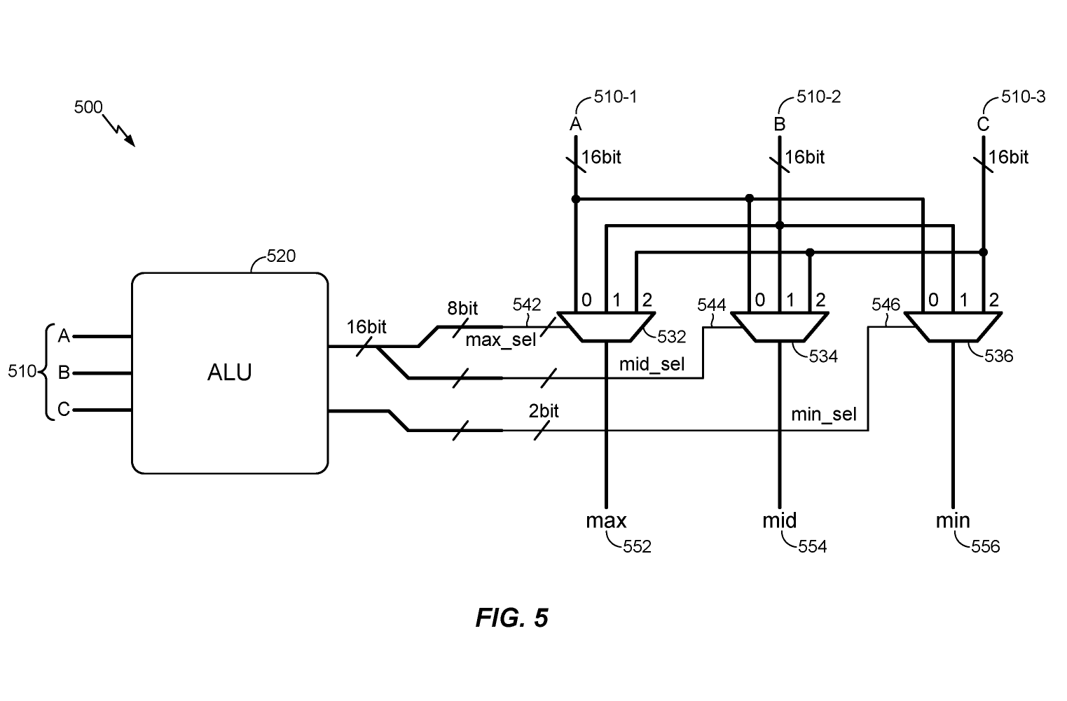

For example, according to various aspects, FIG. 6 illustrates an exemplary comparison circuit 600 that may be implemented in the ALU 520 in context with the data sorting circuit 500 shown in FIG. 5. In particular, the comparison circuit 600 may be arranged to receive the three individual input values 510-1, 510-2, 510-3 to be sorted into the maximum value 552, the middle value 554, and the minimum value 556. The comparison circuit 600 therefore has three comparators, including a first comparator 612 that performs a first ‘greater than’ operation between input ‘A’ 510-1 and input ‘B’ 510-2 and generates an output (gtAB) 622 that indicates whether input ‘A’ 510-1 is greater than input ‘B’ 510-2 (i.e., the output gtAB 622 is one (1) if A>B; otherwise the output gtAB 622 is zero (0)). In a similar respect, a second comparator 614 may perform a second ‘greater than’ operation between input ‘A’ 510-1 and input ‘C’ 510-3 and generate an output (gtAC) 624 that indicates whether input ‘A’ 510-1 is greater than input ‘C’ 510-3, while a third comparator 616 may perform a third ‘greater than’ operation between input ‘B’ 510-2 and input ‘C’ 510-3 and generate an output (gtBC) 626 that indicates whether input ‘B’ 510-2 is greater than input ‘C’ 510-3. As such, the three outputs 622, 624, 626 may collectively convey the order into which the three individual input values 510-1, 510-2, 510-3 should be sorted. As such, with reference to FIG. 5, the ALU 520 may include suitable encode logic (not explicitly shown) that may map values for the three outputs 622, 624, 626 to values to be driven on the two-bit select signals 542, 544, 546 to be input to each respective multiplexer 532, 534, 536.

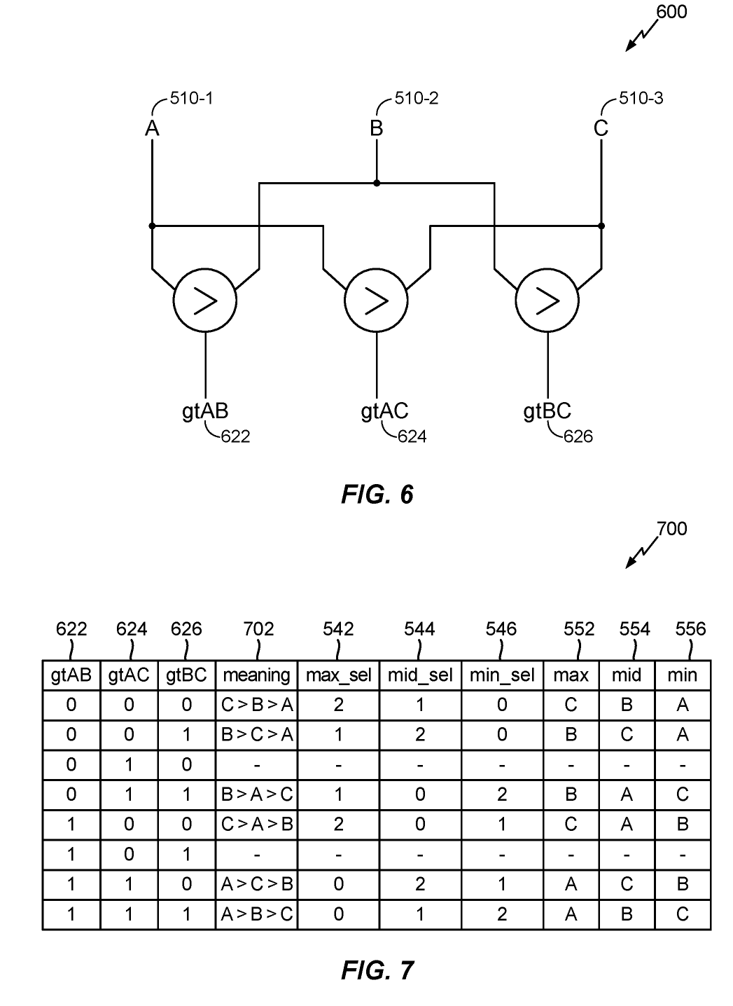

For example, according to various aspects, FIG. 7 illustrates a table 700 that shows exemplary combinations of values for various signals used to drive the sorting instruction as shown in FIG. 5 and FIG. 6. For example, when gtAB 622, gtAC 624, and gtBC 626 all equal 0, the combination of outputs 622, 624, 626 may have a meaning 702 that C>B>A. Accordingly, the select signal 542 coupled to the multiplexer 532 that is configured to output the maximum value 552 may be denoted ‘max_sel’, which may be driven to a value of two (‘10’ as a two-bit binary signal) such that ‘C’ is output as the maximum value 552. Furthermore, the select signal 544 coupled to the multiplexer 534 configured to output the middle value 554 may be denoted ‘mid_sel’, which may be driven to a value of one (‘01’ in two-bit binary) such that ‘B’ is output as the middle value 554, while the select signal 546 coupled to the multiplexer 536 configured to output the minimum value 556 is denoted ‘min_sel’, which is driven to a value of zero (‘00’ in two-bit binary) such that ‘A’ is output as the minimum value 556. The remaining rows in the table 700 show other possible combinations of values and their corresponding meanings 702, which those skilled in the art will appreciate and understand in context with the circuit designs shown in FIG. 5 and FIG. 6. Furthermore, those skilled in the art will appreciate that the table 700 includes two rows that represent impossible results but are nonetheless include for clarity and completeness (e.g., in cases where A is less than or equal to B and B is less than or equal to C such that gtAB 622 and gtBC 626 are zero, gtAC 624 cannot be one because A cannot be greater than C). In this manner, a reconfigurable computing engine efficiently implement a three-way sort instruction in hardware in a manner that requires only three comparators, three 3:1 multiplexers, and suitable encode logic.

In addition to reconfigurable computing architectures as specifically described herein, the various illustrative logical blocks, modules, and circuits described in connection with the aspects disclosed herein may be implemented or performed with a general purpose processor (e.g., a microprocessor, controller, microcontroller, state machine, etc.), a digital signal processor (DSP), an application specific integrated circuit (ASIC), a field programmable gate array (FPGA) or other programmable logic device, discrete gate or transistor logic, discrete hardware components, and/or any suitable combination thereof that is designed or can be designed to perform the functions described herein. For example, the sort operation(s) described herein may implemented on suitable processors that have vector units that can perform single instruction multiple data (SIMD) operations and “shuffling” (permutation) instructions to re-arrange the vector elements. Perceivably, those instructions could be extended to “respond” to permutation selections from the ALU performing the sorting comparisons.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The methods, sequences, and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of non-transitory computer-readable medium known in the art. An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in an IoT device. In the alternative, the processor and the non-transitory computer-readable medium may be discrete components in a user terminal.

In one or more exemplary aspects, the functions described herein may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. Furthermore, in accordance with the various illustrative aspects and embodiments described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

What is claimed is:

1. A circuit, comprising:
an arithmetic logic unit (ALU) configured to receive an input signal comprising N input values to be sorted and to drive N select signals that at least indicate a maximum value and a minimum value among the N input values, where N is an integer having a value greater than one; and
an output switching fabric configured to receive the N input values and the N select signals driven by the ALU, wherein the output switching fabric comprises N multiplexers collectively configured to output at least the maximum value and the minimum value among the N input values based on the N select signals.

2. The circuit recited in claim 1, wherein the ALU and the output switching fabric are provided in a switch box associated with a reconfigurable instruction cell array having multiple switch boxes arranged into one or more rows and one or more columns.

3. The circuit recited in claim 1, wherein the N multiplexers are each individually configured to receive the N input values and a respective one of the N select signals.

4. The circuit recited in claim 1, wherein the N select signals comprise at least a first select signal that indicates the maximum value among the N input values and a second select signal that indicates the minimum value among the N input values such that the N multiplexers are configured to output the maximum value based on the first select signal and the minimum value based on the second select signal.

5. The circuit recited in claim 4, wherein the N select signals further comprise a third select signal that indicates a middle value among the N input values such that the N multiplexers are further configured to output the middle value among the N input values based on the third select signal.

6. The circuit recited in claim 1, wherein the ALU comprises a comparison circuit configured to sort the N input values in an ascending order.

7. The circuit recited in claim 6, wherein the comparison circuit comprises N comparators that are each configured to perform a greater than comparison between a pair of input values from among the N input values.

8. The circuit recited in claim 1, wherein the ALU comprises a comparison circuit configured to sort the N input values in a descending order.

9. The circuit recited in claim 8, wherein the comparison circuit comprises N comparators that are each configured to perform a less than comparison between a pair of input values from among the N input values.

10. The circuit recited in claim 1, wherein the ALU and the output switching fabric form one of a plurality of N-way sort units in a median filter configured to output a median value among the N input values.

11. A method, comprising:
receiving, at an arithmetic logic unit (ALU), an input signal comprising N input values to be sorted, where N is an integer having a value greater than one;
driving, by the ALU, N select signals that at least indicate a maximum value and a minimum value among the N input values, the ALU coupled to an output switching fabric comprising N multiplexers arranged to receive the N input values and the N select signals; and
outputting, by the output switching fabric, at least the maximum value and the minimum value among the N input values based on the N select signals.

12. The method recited in claim 11, wherein the ALU and the output switching fabric are provided in a switch box associated with a reconfigurable instruction cell array having multiple switch boxes arranged into one or more rows and one or more columns.

13. The method recited in claim 11, wherein the N multiplexers are each individually arranged to receive the N input values and a respective one of the N select signals.

14. The method recited in claim 11, wherein the N select signals comprise at least a first select signal that indicates the maximum value among the N input values and a second select signal that indicates the minimum value among the N input values such that the N multiplexers are configured to output the maximum value based on the first select signal and the minimum value based on the second select signal.

15. The method recited in claim 14, wherein the N select signals further comprise a third select signal that indicates a middle value among the N input values such that the N multiplexers are further configured to output the middle value among the N input values based on the third select signal.

16. The method recited in claim 11, wherein the ALU comprises a comparison circuit configured to sort the N input values in an ascending order.

17. The method recited in claim 16, wherein the comparison circuit comprises N comparators that are each configured to perform a greater than comparison between a pair of input values from among the N input values.

18. The method recited in claim 11, wherein the ALU comprises a comparison circuit configured to sort the N input values in a descending order.

19. The method recited in claim 18, wherein the comparison circuit comprises N comparators that are each configured to perform a less than comparison between a pair of input values from among the N input values.

20. The method recited in claim 11, wherein the ALU and the output switching fabric form one of a plurality of N-way sort units in a median filter configured to output a median value among the N input values.

21. A reconfigurable instruction cell array comprising:
multiple switch boxes arranged into one or more rows and one or more columns, wherein at least one of the multiple switch boxes comprises:
an arithmetic logic unit (ALU) configured to receive an input signal comprising N input values to be sorted and to drive N select signals that at least indicate a maximum value and a minimum value among the N input values, where N is an integer having a value greater than one; and
an output switching fabric configured to receive the N input values and the N select signals driven by the ALU, wherein the output switching fabric comprises N multiplexers collectively configured to output at least the maximum value and the minimum value among the N input values based on the N select signals.

22. The reconfigurable instruction cell array recited in claim 21, wherein the N multiplexers are each individually configured to receive the N input values and a respective one of the N select signals.

23. The reconfigurable instruction cell array recited in claim 21, wherein the N select signals comprise at least a first select signal that indicates the maximum value among the N input values and a second select signal that indicates the minimum value among the N input values such that the N multiplexers are configured to output the maximum value based on the first select signal and the minimum value based on the second select signal.

24. The reconfigurable instruction cell array recited in claim 23, wherein the N select signals further comprise a third select signal that indicates a middle value among the N input values such that the N multiplexers are further configured to output the middle value among the N input values based on the third select signal.

25. The reconfigurable instruction cell array recited in claim 21, wherein the ALU comprises a comparison circuit configured to sort the N input values in an ascending order.

26. The reconfigurable instruction cell array recited in claim 25, wherein the comparison circuit comprises N comparators that are each configured to perform a greater than comparison between a pair of input values from among the N input values.

27. The reconfigurable instruction cell array recited in claim 21, wherein the ALU comprises a comparison circuit configured to sort the N input values in a descending order.

28. The reconfigurable instruction cell array recited in claim 27, wherein the comparison circuit comprises N comparators that are each configured to perform a less than comparison between a pair of input values from among the N input values.

29. The reconfigurable instruction cell array recited in claim 21, wherein the ALU and the output switching fabric provided in the at least one switch box form one of a plurality of N-way sort units in a median filter configured to output a median value among the N input values.

30. An apparatus, comprising:
means for driving N select signals that at least indicate a maximum value and a minimum value among N input values, where N is an integer having a value greater than one; and
an output switching fabric configured to receive the N input values and the N select signals, wherein the output switching fabric comprises N multiplexers collectively configured to output at least the maximum value and the minimum value among the N input values based on the N select signals.
